(19) United States
(12) Patent Application Publication
(10) Pub. No.: US 2016/0153286 A1
(43) Pub. Date: Jun. 2, 2016

(54) TURBINE CLEARANCE CONTROL UTILIZING LOW ALPHA MATERIAL

(71) Applicant: UNITED TECHNOLOGIES CORPORATION, Hartford, CT (US)

(72) Inventors: Gabriel L. Suciu, Glastonbury, CT (US); Ioannis Alvanos, West Springfield, MA (US)

(21) Appl. No.: 14/905,351

(22) PCT Filed: Jul. 2, 2014
(86) PCT No.: PCT/US2014/045285

§ 371 Date: Jan. 15, 2016

Related U.S. Application Data
(60) Provisional application No. 61/846,324, filed on Jul. 15, 2013.

(51) Int. Cl. F01D 5/28; F02C 3/04

(52) U.S. Cl. CPC F01D 5/28; F02C 3/04

(57) ABSTRACT

A turbine module comprises a stator assembly disposed annularly about a rotor assembly. The rotor assembly includes a plurality of turbine blades circumferentially distributed about a turbine disk. The stator assembly includes at least one case segment and an abradable surface disposed radially adjacent to a tip of each of the plurality of rotor blades. The turbine blades each include an airfoil section with a first gamma-phase titanium aluminide (gamma-TiAl) substrate, and the at least one case segment has a second gamma-TiAl substrate.

### BACKGROUND

The described subject matter relates generally to turbine engines, and more specifically to managing tip clearance in gas turbine engines.

Due to the high temperatures resulting from passage of combustion gases, various components of the turbine section are made from temperature resistant alloys. The most common class of alloys used for turbine components is a nickel-based superalloy. Though many have very high thermal and creep resistance, nickel-based superalloys also undergo substantial thermal expansion over their operating range. Large dimensional variability of the airfoil, caused by a relatively high coefficient of thermal expansion (CTE or α), results in excessive rubbing and/or excessive tip clearance, both of which are detrimental to performance and efficiency. This makes it difficult to manage clearances between the airfoil tips and the adjacent case without use of a clearance control system. However, a clearance control system, in order to help match the dimensions of the case and the rotor, requires diversion of coolant from the bleed system. An active clearance control system also includes a number of valves and conduits which further adds to the weight of the engine.

### SUMMARY

A turbine module is disclosed which has a stator assembly disposed annularly about a rotor assembly. The rotor assembly includes a plurality of turbine blades circumferentially distributed about a turbine disk. The stator assembly includes at least one case segment and an abradable surface disposed radially adjacent to a tip of each of the plurality of rotor blades. The turbine blades each include an airfoil section with a first gamma-phase titanium aluminide (gamma-TiAl) substrate, and the at least one case segment has a second gamma-TiAl substrate.

A gas turbine engine is disclosed which includes a compressor section, a combustor section, and a turbine section. The turbine section has a turbine module with a stator assembly disposed annularly about a rotor assembly. The rotor assembly includes a plurality of gamma-phase titanium aluminide (gamma-TiAl) turbine blades circumferentially distributed about a turbine disk. The stator assembly has a gamma-TiAl case disposed annularly about the rotor assembly with an abradable surface of the case disposed radially adjacent to a tip of each rotor blade.

### BRIEF DESCRIPTION OF THE DRAWINGS

FIG. 1 depicts an exemplary, non-limiting embodiment of a gas turbine engine.

FIG. 2 shows an example section of a low pressure turbine module with gamma-TiAl blades, vanes, disks, and outer case.

FIG. 3 is a magnified view of a portion of the blade tip clearance region of the low pressure turbine module.

FIG. 4 is a normalized graph comparing results of simulations comparing tip clearance of a gamma-TiAl module without a clearance control system, to a standard nickel-based superalloy module with a passive clearance control system.

### DETAILED DESCRIPTION

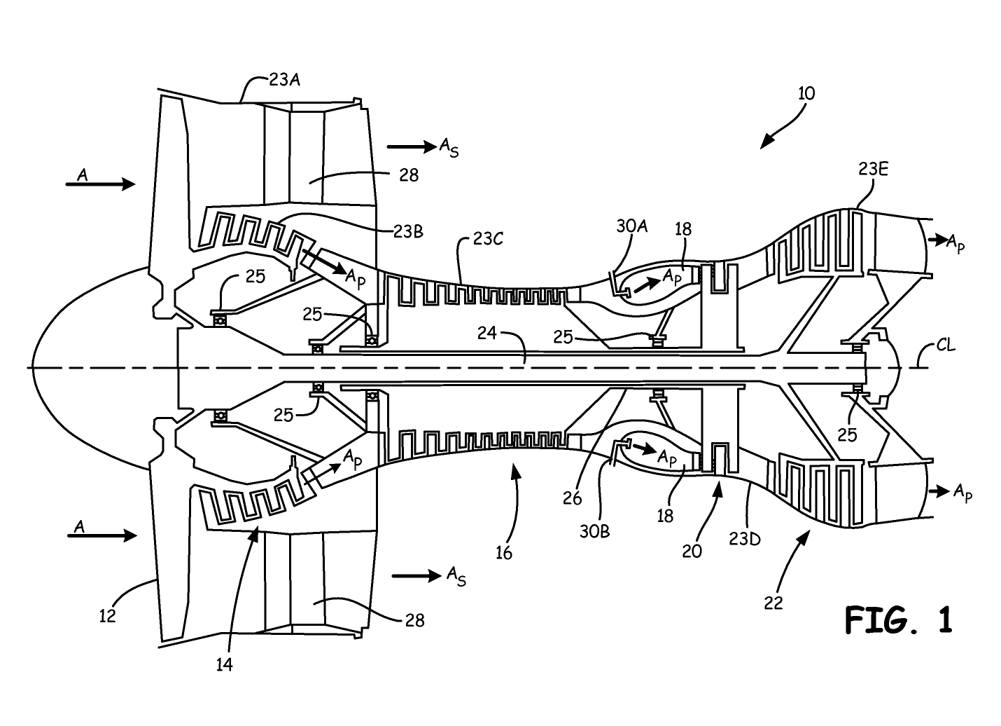

FIG. 1 shows a schematic cross section of gas turbine engine 10. In the embodiment shown, gas turbine engine 10 comprises a dual-spool, high bypass ratio turbofan engine. In other embodiments, gas turbine engine 10 comprises other types of gas turbine engines used for aircraft propulsion or power generation, or other similar systems, including a three-spool gas turbine engine configuration. Although the described subject matter is well suited for a low pressure turbine section of dual-spool, high bypass ratio turbofan engines, the subject matter is readily applicable to other turbine sections of the dual-spool, high bypass ratio turbofan engine and turbine sections of other turbine engines in which the thermal limitations of the materials are not exceeded.

Gas turbine engine 10, of which the operational principles are well known in the art, comprises fan 12, low pressure compressor (LPC) 14, high pressure compressor (HPC) 16, combustor section 18, high pressure turbine (HPT) 20 and low pressure turbine (LPT) 22, which are each concentrically disposed around axial engine centerline CL. Fan 12, LPC 14, HPC 16, HPT 20, LPT 22 and other engine components are enclosed at their outer diameters within various engine casings, including fan case 23A, LPC case 23B, HPC case 23C, HPT case 23D and LPT case 23E. Fan 12 and LPC 14 are connected to LPT 22 through low pressure shaft 24. Together, fan 12, LPC 14, LPT 22 and low pressure shaft 24 comprise the low pressure spool. HPC 16 is connected to HPT 20 through high pressure shaft 26. Together, HPC 16, HPT 20 and high pressure shaft 26 comprise the high pressure spool. Bearings 25 support low pressure shaft 24 and high pressure shaft 26.

A working fluid such as inlet air A enters engine 10 whereby it is divided into streams of primary air A_{P} and secondary air A_{S} after passing through fan 12. Fan 12 is rotated by low pressure turbine 22 through low pressure shaft 24 to accelerate secondary air A_{S} (also known as bypass air) through exit guide vanes 28, thereby producing a significant portion of the thrust output of engine 10. Primary air A_{P} (also known as gas path air) is directed first into low pressure compressor 14 and then into high pressure compressor 16. LPC 14 and HPC 16 work together to incrementally increase the pressure and temperature of primary air A_{P}. HPC 16 is rotated by HPT 20 through high pressure shaft 26 to provide compressed air to combustor section 18. The compressed air is delivered to combustor 18, along with fuel from injectors 30A and 30B, such that a combustion process can be carried out to produce high energy combustion products used to turn high pressure turbine 20 and low pressure turbine 22. Primary air A_{P} continues through gas turbine engine 10 whereby it is typically passed through an exhaust nozzle to further produce thrust.

To reduce dimensional variability, a lower a material can be selected for use throughout at least one of the turbine modules. However, few materials apart from superalloys are able to withstand the wide range of thermal conditions (both hot and cold) seen inside the turbine module. Use of a lower a material such as titanium aluminide for LPT 22 and LPT case 23E, can allow LPT 22 and LPT case 23E to be isolated from an engine bleed air system. An example bleed air system draws air from LPC 14 through one or more ports (not shown) in LPC case 23B.

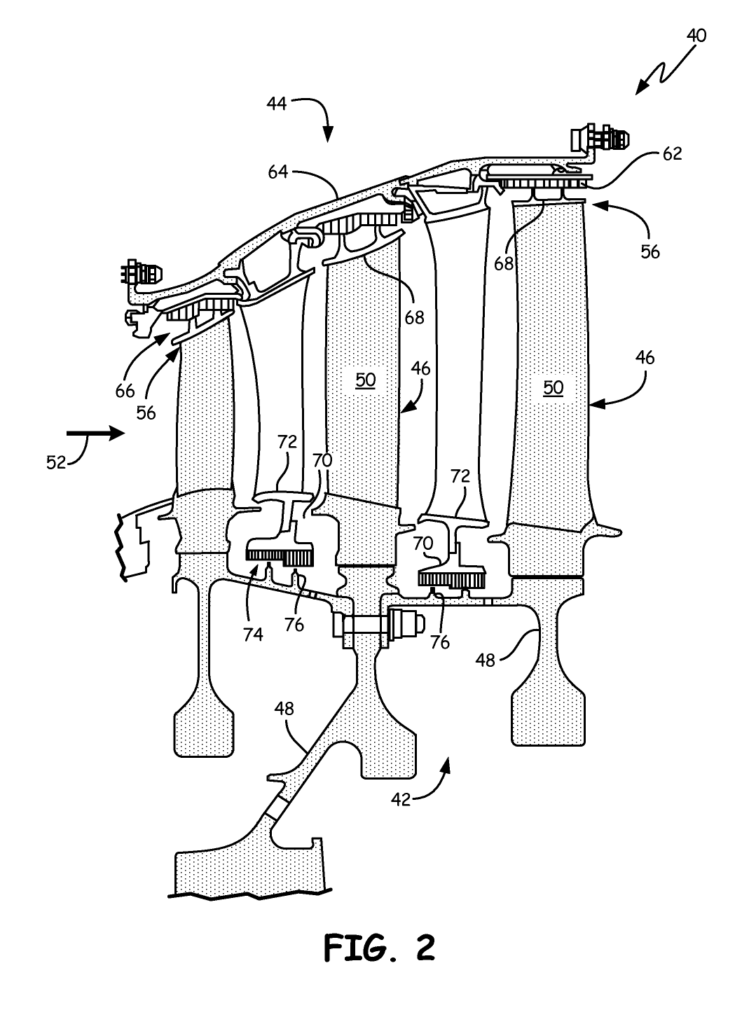

FIG. 2 shows a detailed section of a low pressure turbine module with gamma-TiAl blades, vanes, disks, and outer case. In FIG. 2, turbine module 40 includes stator assembly 44 disposed annularly about rotor assembly 42. A plurality of turbine blades 46 are circumferentially distributed about turbine disk 48. Each turbine blade 46 includes airfoil section 50 disposed across working gas passage 52.

Turbine stator assembly 44 is disposed radially outward of respective tip sections 56 of each of the plurality of turbine blades 46. Each stage of stator assembly 44 includes at least one outer air seal 58 and vane 60 each supported by outer turbine case 64, which has forward and aft ends for connecting stator assembly 44 to axially adjacent engine modules. Outer turbine case 64, which may be a full ring or split ring case, supports outer air seals 58 or other structures each having abradable surfaces 62. Abradable surfaces 62 face radially inward to define portions of an outer flow boundary of working gas passage 52, radially outward of turbine blades 46. The abradable material of surface 62 interacts with turbine blade tip sections 56 to form outer rub interface 66. In one example, each rotor blade tip section 56 includes shroud 68 with at least one knife edge. However, it will be appreciated that rotor blade tip sections 56 may have a tip shelf or tip cap in place of shroud 68, each of which have at least one contact surface forming outer rub interface 66 with outer air seal 58.

In certain embodiments, one or more vanes 60 have inner air seal 70 disposed on a radially inner portion thereof. FIG. 2 shows vanes 60 as being cantilevered, with respective inner air seals 70 fastened to vane free end 72. Inner air seals 70 can also include an abradable surface which interacts with rotor knife edges 76 (on rotor assembly 40) to form inner rub interface(s) 74.

In at least one stage of turbine module 40, airfoil section 50 comprises a first gamma-phase titanium aluminide (gamma-TiAl) substrate with a first composition, and outer case segment(s) 64 comprise a second gamma-TiAl substrate with a second composition. In certain embodiments, turbine disk 48 also comprises a gamma-TiAl substrate, and has a third composition. In certain embodiments, one or more turbine vanes 60 also comprise a gamma-TiAl substrate, and has a fourth composition.

A low α (i.e., low CTE) material such as gamma-phase titanium aluminide (gamma-TiAl), when used as a substrate material for both turbine blade airfoil sections 50 and case section(s) 64, allows for improved growth matching throughout the engine operating cycle as compared to superalloys, thereby reducing the range of gap clearances seen in outer rub interface 66. In certain embodiments, the reduction in gap clearance range is sufficient to result in downsizing or outright elimination of an active or passive clearance control system. This further reduces weight, complexity, and costs as compared to superalloy-based modules.

Gamma-TiAl alloys have recently been used for certain low temperature turbine blade applications. However, their use as a case or disk material has been limited by processing difficulties and thermal resistance. For example, turbine disks and cases are typically formed via powder metallurgy. However, it has been documented that previous compositions of gamma-TiAl alloys are prone to pitting and porosity when used in powder metallurgy, which weakens the structure and requires further consolidation to improve high temperature performance. Recent advances in compositions and processing of higher temperature gamma-TiAl alloys also allow a turbine module to utilize gamma-TiAl turbine disks and segmented cases such as is described in the present matter. The first, second, third, and/or fourth gamma-TiAl substrates may be coated or may have other materials deposited thereon to further improve thermal, mechanical, and environmental performance tailored to each component.

Portions of shroud 68 can receive an abrasive coating to strengthen them against rub damage and preferentially wear away abradable surface(s) 62. In certain alternative embodiments, shroud 68 (or alternatively a tip cap) is formed from a different substrate material other than TiAl, which is then metallurgically bonded to airfoil 50 to form at least a portion of tip section 56. The small radial dimension of shroud 68 (relative to airfoil section 50), is minimally affected by thermal expansion, and thus shroud 62 can be tailored to the mechanical stresses seen during blade rubbing with a manageable effect on overall growth matching.

Gamma-TiAl and alpha-TiAl are present in a number of intermetallic compounds. For purposes of this description, it is helpful to reduce the volumetric percentage of alpha-TiAl phase in the substrate in order to reduce fatigue and creep effects caused by lamellar grain boundaries between the alpha and gamma phase regions. Thus in certain embodiments, at least one of the first composition and the second composition includes less than about 15 vol % alpha-TiAl. In certain embodiments, at least one of the first composition and the second composition includes less than about 5 vol % alpha-TiAl.

In certain embodiments, the second composition may be substantially identical to the first composition, with any thermal differences managed through the use of coatings or other surface treatments. However, the precise compositions and processing steps can be varied to tailor performance requirements for each part.

In certain other embodiments, the second (case) composition may be substantially different from the first (airfoil) composition. For example, the turbine case (second composition) may have a slightly higher alpha-TiAl percentage than the blades (first composition). To prevent stresses from differential thermal expansion in and around the root, the disk (third composition) can be made substantially identical to the first composition. In certain of these embodiments, the plurality of turbine blades can be joined to the turbine disk to form an integrally bladed rotor (IBR).

Minimizing the alpha-TiAl phase is most helpful in blades (first composition) and vanes (fourth composition). The airfoils are exposed to more rapid thermal gradients and overall higher temperatures in the center of the flowpath making them vulnerable to both fatigue and creep. To improve resistance, the first and/or fourth compositions can be adjusted by varying the aluminum concentration and/or by introducing additives so as to increase the occurrence of beta-TiAl precipitates around grain boundaries between the alpha and gamma TiAl. In certain of these embodiments, the airfoil components can be solution heat-treated after casting to increase the occurrence of beta-TiAl precipitates in the gamma-TiAl substrate, and otherwise improve creep resistance. For example, the gamma TiAl substrate can be treated at or above about 1232° C. (2250° F.) for at least an hour. The heat treatment temperature and/or duration can be increased to improve creep resistance; however, the improved creep resistance can sometimes come at the cost of low or ambient temperature ductility.

Alternatively, lower temperature gamma-TiAl alloys (including those with higher alpha phase volume percentages) can be used for the turbine case (second composition) and/or disk (third composition). This may be suitable for applications where there is sufficient opportunity for turbine preheating and/or long operational cycles (e.g., for ground-based turbines).

Reducing the alpha-TiAl percentage in each composition can increase material and processing costs due to the use of additional alloying elements and/or more complex processing. However, these costs can be offset by savings from cooling and maintenance requirements resulting from less blade rubbing. Additional operational and maintenance savings are also seen by reducing the need to separately manage tip clearance through the use of bleed air or other means.

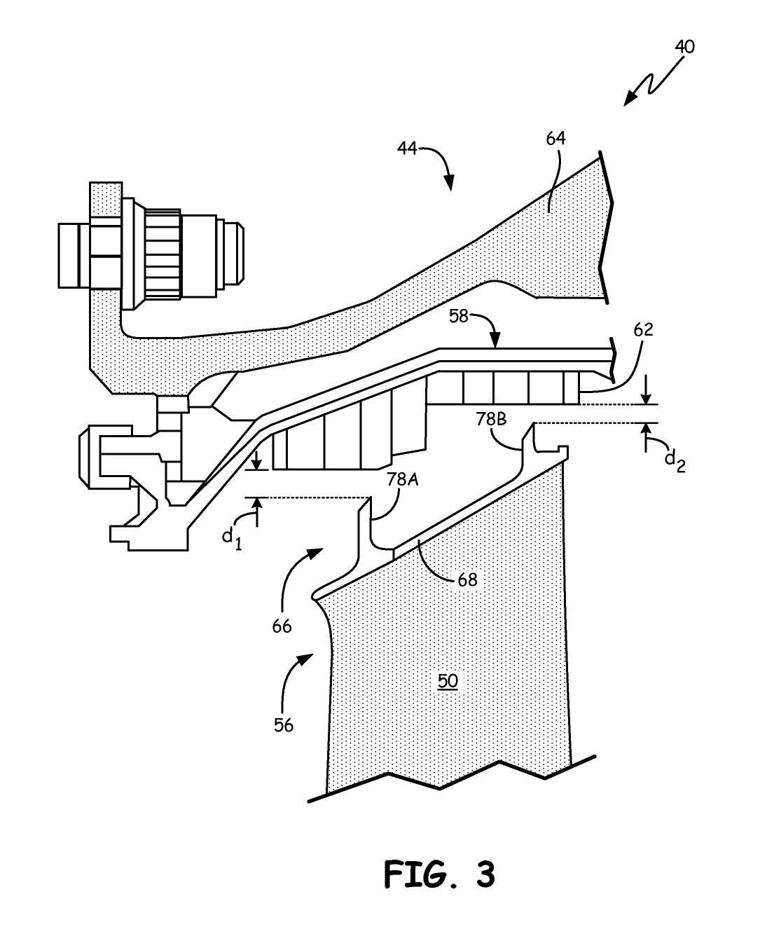

FIG. 3 is a magnified view of one stage of turbine module 40 proximate the outer tip clearance region (i.e., outer rub interface 66). As above, stator assembly 44 includes outer air seal 58 supported by gamma-TiAl turbine case segment 64. Case segment 64 has abradable surface 62 which forms outer rub interface(s) 66 with tip section 56 of gamma-TiAl airfoil 50.

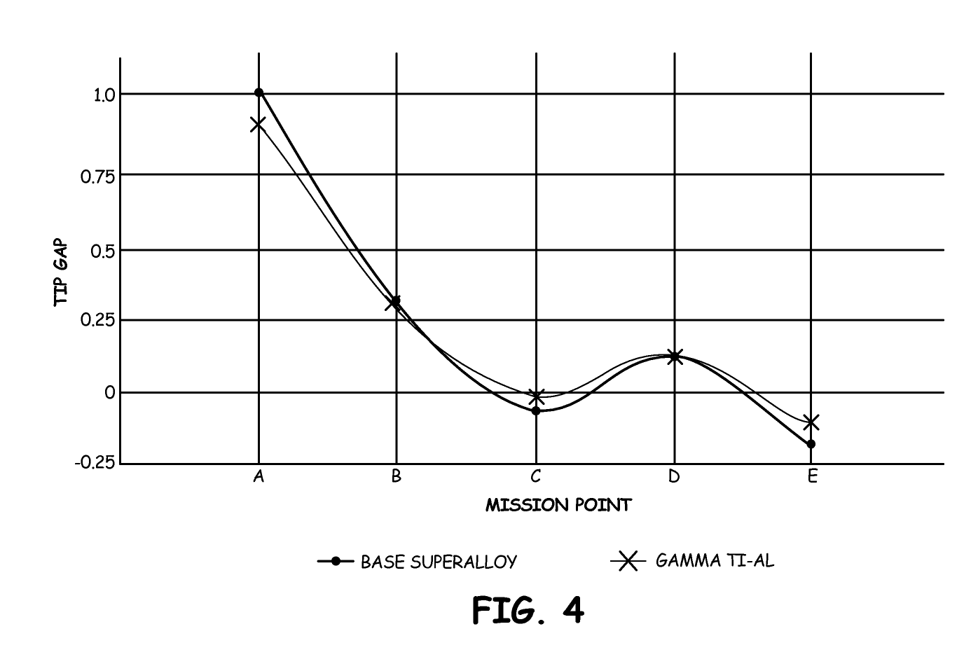

Outer rub interface(s) 66 have at least one tip gap formed between abradable surface 62 and tip section 56. Here, there are two gaps for each knife edge 78A, 78B represented by corresponding gap distances d₁ and d₂. The values shown in FIG. 4 represent the larger magnitude between the two distances d₁ and d₂. In alternative embodiments, tip clearance can be measured at a single point or at more than two points, for example, when shroud 68 is replaced by a tip cap or tip rib.

An ordinary flight cycle puts the engine through five primary operating events or mission points: (A) Assembly/Ambient; (B) Warmup/Acceleration; (C) Takeoff/Max Climb; (D) Cruise/ADP; and (E) Deceleration/Landing. The radial dimension of the gap(s) varies somewhat predictably after transitioning to the next mission point. The goal is to minimize the overall gap through the operating range while also minimizing the occurrence and severity of tip rubbing particularly during max climb events. This can be achieved in part by reducing the overall range of differential thermal expansion between the rotor and the case and adjusting the overall clearance curve to match or slightly improve upon acceptable intermediate tip clearances.

Many superalloy turbine modules utilize a clearance control system to reduce this range of variability. Active clearance control systems, which are well known, generally utilize a ring around the outer case which carries cooler bleed air. When the system is activated, coolant in the ring reduces the entire stator temperature and thus prevents the case from expanding to its fullest degree. Passive systems, which are less complex and have less mass than active systems, typically operate by directly impingement cooling the outer case. This system is lighter but also less effective than active systems and still utilizes bleed air. There is typically a tradeoff between the efficiency gain from tighter tip clearances and the efficiency loss from the use of bleed air, and the additional weight of active systems. As shown in FIG. 4,

FIG. 4 shows results of a simulation comparing the tip clearances of two similarly sized turbine modules at various typical operating events, or mission points (A)-(E) described with respect to FIG. 3. In the comparison of FIG. 4, the baseline turbine module assumes mechanical and fatigue properties of a low-sulfur version of a nickel-based superalloy substrate for the blades, outer case, and rotor disk. The comparison module assumes properties of a conventional gamma-TiAl alloy substrate for the blades, outer case, and rotor disk.

Tip clearances are shown in the graph on a relative, dimensionless scale. In this scale, 1.000 represents the maximum clearance after assembly of the baseline engine module while 0.000 represents a condition where there is no gap. The value shown in the graph represents the smaller of gap d₁ and d₂ (shown in FIG. 3).

In FIG. 4, it can be seen that the initial or startup tip clearance for the comparison gamma-TiAl module is about 10% smaller than that of the baseline module. This permits tighter assembly tolerances. In addition, the depth of tip rubbing (represented by negative clearance) in a max climb condition, is also substantially reduced relative to the baseline module. Tip clearance of the comparison gamma-TiAl module during other events is also comparable to or less than tip clearance of the baseline module.

To achieve the results shown in FIG. 4, the baseline turbine module also requires a passive clearance control system, which impinges cooling air onto the outer case. The comparison gamma-TiAl module achieves these improved tip clearances without active or passive clearance control.

The simulation referenced in FIG. 4 did not seek to maximize creep resistance. However, it will be appreciated that the balance of creep resistance and ductility of a particular gamma-TiAl substrate can be optimized through variations in the composition and/or processing of each component.

### Discussion of Possible Embodiments

The following are non-exclusive descriptions of possible embodiments of the present description.

A turbine module is disclosed which has a stator assembly disposed annularly about a rotor assembly. The rotor assembly includes a plurality of turbine blades circumferentially distributed about a turbine disk. The stator assembly includes at least one case segment and an abradable surface disposed radially adjacent to a tip of each of the plurality of rotor blades. The turbine blades each include an airfoil section with a first gamma-phase titanium aluminide (gamma-TiAl) substrate, and the at least one case segment has a second gamma-TiAl substrate.

The component of the preceding paragraph can optionally include, additionally and/or alternatively, any one or more of the following features, configurations and/or additional components:

A turbine module according to an exemplary embodiment of this disclosure, among other possible things includes a rotor assembly including a plurality of turbine blades circumferentially distributed about a turbine disk, the plurality of turbine blades each including an airfoil section with a first gamma-phase titanium aluminide (gamma-TiAl) substrate; and a stator assembly disposed annularly about the rotor assembly, the stator assembly including an abradable surface disposed radially adjacent to a tip of each of the plurality of rotor blades. The stator assembly includes at least one case segment with a second gamma-TiAl substrate.

A further embodiment of the foregoing turbine module, wherein the first gamma-TiAl substrate includes a first composition and the second gamma-TiAl substrate includes a second composition.

A further embodiment of any of the foregoing turbine modules, wherein at least one of the first composition and the second composition includes less than about 15 vol % alpha-TiAl.

A further embodiment of any of the foregoing turbine modules, wherein at least one of the first composition and the second composition includes less than about 5 vol % alpha-TiAl.

A further embodiment of any of the foregoing turbine modules, wherein the second composition is substantially different from the first composition.

A further embodiment of any of the foregoing turbine modules, wherein the second composition is substantially identical to the first composition.

A further embodiment of any of the foregoing turbine modules, wherein the turbine disk includes a gamma-TiAl substrate with a third composition.

A further embodiment of any of the foregoing turbine modules, wherein the third composition is substantially identical to the first composition.

A further embodiment of any of the foregoing turbine modules, wherein the plurality of turbine blades are joined to the turbine disk to form an integrally bladed rotor (IBR).

A further embodiment of any of the foregoing turbine modules, wherein the stator assembly further comprises a plurality of turbine vanes circumferentially distributed about the at least one case segment, each vane including an airfoil section with a fourth gamma-phase titanium aluminide (gamma-TiAl) substrate.

A gas turbine engine is disclosed which includes a compressor section, a combustor section, and a turbine section. The turbine section has a turbine module with a stator assembly disposed annularly about a rotor assembly. The rotor assembly includes a plurality of gamma-phase titanium aluminide (gamma-TiAl) turbine blades circumferentially distributed about a turbine disk. The stator assembly has a gamma-TiAl case disposed annularly about the rotor assembly with an abradable surface of the case disposed radially adjacent to a tip of each rotor blade.

The component of the preceding paragraph can optionally include, additionally and/or alternatively, any one or more of the following features, configurations and/or additional components:

A turbine module according to an exemplary embodiment of this disclosure, among other possible things includes a compressor section including a compressor module adapted to compress a working fluid; a combustor section adapted to mix fuel with the working fluid compressed by the compressor module and discharge resulting combustion products; and a turbine section including a turbine module adapted to receive combustion products from the combustor. The turbine module includes a stator assembly disposed annularly about a rotor assembly, the rotor assembly having a plurality of gamma-phase titanium aluminide (gamma-TiAl) turbine blades circumferentially distributed about a turbine disk. The stator assembly has a gamma-TiAl case disposed annularly about the rotor assembly with an abradable surface of the gamma-TiAl case disposed radially adjacent to a tip of each rotor blade.

A further embodiment of the foregoing engine, wherein the gamma-TiAl turbine blades each include a first composition and the gamma-TiAl case includes a second composition.

A further embodiment of any of the foregoing engines, wherein at least one of the first composition and the second composition includes less than about 15 vol % alpha-TiAl.

A further embodiment of any of the foregoing engines, wherein at least one of the first composition and the second composition includes less than about 5 vol % alpha-TiAl.

A further embodiment of any of the foregoing engines, wherein the second composition is substantially different from the first composition.

A further embodiment of any of the foregoing engines, wherein the second composition is substantially identical to the first composition.

A further embodiment of any of the foregoing engines, wherein the turbine disk comprises gamma-TiAl with a third composition.

A further embodiment of any of the foregoing engines, wherein the third composition is substantially identical to the first composition.

A further embodiment of any of the foregoing engines, wherein the plurality of turbine blades are joined to the turbine disk to form an integrally bladed rotor (IBR).

A further embodiment of any of the foregoing engines, wherein the at least one casing segment is isolated from the engine bleed air system.

Although the present invention has been described with reference to preferred embodiments, workers skilled in the art will recognize that changes may be made in form and detail without departing from the spirit and scope of the invention.

1. A turbine module comprising:
a rotor assembly including a plurality of turbine blades circumferentially distributed about a turbine disk, the plurality of turbine blades each including an airfoil section with a first gamma-phase titanium aluminide (gamma-TiAl) substrate; and
a stator assembly disposed annularly about the rotor assembly, the stator assembly including an abradable surface disposed radially adjacent to a tip of each of the plurality of rotor blades, the stator assembly including at least one case segment with a second gamma-TiAl substrate.

2. The turbine module of claim 1, wherein the first gamma-TiAl substrate includes a first composition and the second gamma-TiAl substrate includes a second composition.

3. The turbine module of claim 2, wherein at least one of the first composition and the second composition includes less than about 15 vol % alpha-TiAl.

4. The turbine module of claim 2, wherein at least one of the first composition and the second composition includes less than about 5 vol % alpha-TiAl.

5. The turbine module of claim 2, wherein the second composition is substantially different from the first composition.

6. The turbine module of claim 2, wherein the second composition is substantially identical to the first composition.

7. The turbine module of claim 1, wherein the turbine disk includes a gamma-TiAl substrate with a third composition.

8. The turbine module of claim 1, wherein the third composition is substantially identical to the first composition.

9. The turbine module of claim 8, wherein the plurality of turbine blades are joined to the turbine disk to form an integrally bladed rotor (IBR).

10. The turbine module of claim 1, wherein the stator assembly further comprises:
a plurality of turbine vanes circumferentially distributed about the at least one case segment, each vane including an airfoil section with a fourth gamma-phase titanium aluminide (gamma-TiAl) substrate

11. A gas turbine engine comprising:
a compressor section including a compressor module adapted to compress a working fluid;
a combustor section adapted to mix fuel with the working fluid compressed by the compressor module and discharge resulting combustion products; and
a turbine section including a turbine module adapted to receive combustion products from the combustor, the turbine module including a stator assembly disposed annularly about a rotor assembly, the rotor assembly having a plurality of gamma-phase titanium aluminide (gamma-TiAl) turbine blades circumferentially distributed about a turbine disk, and the stator assembly having a gamma-TiAl case disposed annularly about the rotor assembly with an abradable surface of the gamma-TiAl case disposed radially adjacent to a tip of each rotor blade.

12. The engine of claim 11, wherein the gamma-TiAl turbine blades each include a first composition and the gamma-TiAl case includes a second composition.

13. The engine of claim 12, wherein at least one of the first composition and the second composition includes less than about 15 vol % alpha-TiAl.

14. The engine of claim 12, wherein at least one of the first composition and the second composition includes less than about 5 vol % alpha-TiAl.

15. The engine of claim 12, wherein the second composition is substantially different from the first composition.

16. The engine of claim 12, wherein the second composition is substantially identical to the first composition.

17. The engine of claim 11, wherein the turbine disk comprises gamma-TiAl with a third composition.

18. The engine of claim 11, wherein the third composition is substantially identical to the first composition.

19. The engine of claim 18, wherein the plurality of turbine blades are joined to the turbine disk to form an integrally bladed rotor (IBR).

20. The engine of claim 11, wherein the at least one casing segment is isolated from an engine bleed air system.
